(19) United States
(12) Patent Application Publication
(10) Pub. No.: US 2017/0121087 A1
(43) Pub. Date: May 4, 2017

(54) METHOD OF CAPPING A HOLLOW CONTAINER, CAPPED CONTAINER OBTAINED BY SUCH A METHOD AND USE OF SUCH A CAPPED CONTAINER

(71) Applicant: SIDEL PARTICIPATIONS, Octerville-sur-mer (FR)

(72) Inventor: Mikael DERRIEN, Octeville-sur-mer (FR)

(21) Appl. No.: 15/301,514

(22) PCT Filed: Mar. 23, 2015
(86) PCT No.: PCT/FR2015/050720

§ 371 Date: Oct. 3, 2016

(30) Foreign Application Priority Data
Apr. 2, 2014 (FR) 14 52934

(51) Int. Cl. B65D 77/20; B65B 61/18; B29C 65/00; B65B 7/16

(52) U.S. Cl. CPC B65D 77/208; B65B 7/165; B65B 7/164; B65B 61/18; B29C 66/53461; B29C 66/73921; B29C 66/81425; B29C 66/8322; B29L 2031/7158

(57) ABSTRACT

The invention relates to a method of capping a hollow container, the container including a neck which defines an opening towards the interior of the container, the capping method including the following steps: placing a film over the entire edge of the opening in the container so as to cover the opening; deep drawing the film in the opening in the neck of the container with a die, such that the film forms a collar, a central region and a riser at the junction between the collar and the central region, the riser being in contact with the inner wall of the neck; and securing the deep drawn film to the neck, thus rendering the film integral with the body of the container.

The invention relates to a container, such as those that can commonly be found for liquids or food products, the method of capping a container, and its use.

Generally, the invention relates to the field of the capping of containers, particularly bottles and cartons, of the type of those that comprise a neck, the neck forming a constriction on the container.

In fact, a container in general comprises a body, defining a volume for filling, closed by a bottom at a lower end. The body is topped by an open neck, having a cross-section that is smaller than that of the body and therefore forming a constriction, so as to facilitate the flow of the product out of the container. The body is, for example, obtained by blow molding or stretch blow molding of a preform made of thermoplastic material, the neck being previously attached to, or more commonly an integral part of, the preform. The body can also be a carton, for example made of paperboard, on which a plastic neck is mounted. Once the body is filled, a capping system is added to the neck to close the container.

Two categories of capping systems are commonly found on the market.

A first category consists in forming, on the neck, temporary mounting means with a cap. The cap appears in the form of a rigid part, for example made of plastic, whose dimensions allow it to cover the neck and the opening. The temporary mounting means are, for example, of the snap-on type, or else of the threading-on-the-neck type working with a counter-thread of the cap.

The document EP 0 941 938 illustrates an example of a capping system of this first category.

Such caps have, in particular, the advantage of offering a secure, even fluidtight, closing, and of making it possible to remove the cap to open the container and to put the cap back in place to reclose the container in a fluidtight manner repeatedly, without degrading the quality of the closing.

However, such rigid caps are expensive to manufacture. Further, they require the putting in place of mounting means that are exclusive to their placement on the neck, complying with the dimensions that are adapted to the cap, making the shape of the neck complex, and therefore again increasing the manufacturing costs.

The second category consists in applying a sheet made of a flexible material, typically of aluminum, over the the opening and covering the neck. The sheet is then mounted onto the neck for example by adhesion or by heat-sealing. To open the container, the mounting of the sheet on the neck must be broken. In this second category, the sheet can be accompanied by an overcap, i.e., an additional cap, added above the sheet.

One advantage of this second category of capping systems is that, when the sheet is not accompanied by an overcap, the costs are reduced relative to the caps of the first category. In fact, the amount of material constituting the sheet is less than that of the caps of the first category. In addition, the mounting of the sheet on the neck does not require forming additional means on the neck, simplifying the design and the manufacture of the neck. This is why this second category of capping systems is generally placed on bottles whose necks are not long enough to make possible the formation of such additional means.

Nevertheless, once the mounting between the sheet and the neck is broken, the sheet is not able to reclose the container. In fact, even if the sheet can be placed over the opening of the neck, there are no longer mounting means. The container can no longer be closed in a fluidtight manner. The contents can then inadvertently spill out of the container, or foreign bodies can enter into the container.

Therefore, a need exists for a container equipped with a new capping system that solves in particular the previously-cited drawbacks.

For this purpose, the invention, according to a first aspect, proposes a method of capping a hollow container. The container comprises a body that extends between an upper end and a lower end, the upper end being topped by a neck forming a narrowing on the container and defining an opening to the interior of the container, and the lower end comprising a bottom that closes the container. The capping method comprises the following steps:
the application of a sheet over the entire edge of the opening of the container in such a way as to cover the opening,
the deep drawing of the sheet into the opening of the neck of the container by a die, so that the sheet forms a collar pressed against the entire edge of the opening, a central area surrounded by the collar and being located in a plane that is offset relative to this collar, and a junction area between the collar and the central area, the junction area forming a riser in contact with the interior wall of the neck,
the mounting of the sheet that is deep drawn onto the neck ensuring the interlocking of the sheet onto the body of the container.

The capping method according to the invention makes it possible in particular to form a cap from a sheet in a simple and economic manner. The sheet shaped during the deep drawing operation has a shape that is suitable for a subsequent recapping.

According to the invention, the method can have the following characteristics:
the sheet is made of thermoplastic material, which makes it particularly low in cost, and particularly suitable for deep drawing. Actually, the ductility of the sheet made of thermoplastic material can be easily controlled by heating;
the sheet comprises at least one portion that extends beyond the edge of the opening, so as to form a gripping area after the deep drawing step. The gripping area makes it possible in particular to facilitate opening of the container by pulling on the shaped sheet;
the mounting step comprises a step for sealing between the sheet and the neck. The sealing makes possible a reliable and rapid mounting between the neck and the sheet;
the sealing is performed between the collar and the entire edge of the opening, so that the collar of the sheet is in fluidtight contact with the edge of the opening. The preservation of the contents of the container is thus guaranteed;
the sealing is performed between the riser and the interior wall of the neck, so that the riser is in fluidtight contact with the interior wall of the neck;
the sealing step is simultaneous with the deep drawing step, reducing the time for implementing the method, and therefore the costs;
the mounting step comprises a step for adhesion between the sheet and the neck. The adhesion also constitutes a means that is suited, in terms of costs, for obtaining an adequate mounting owing to the sheet on the neck;
the deep drawing step is accompanied by a step for heating the sheet, so as to facilitate the shaping of the cap of the sheet;
the neck of the container is made of thermoplastic material;
the body of the container is made of thermoplastic material. The body is thus obtained by, for example, a method of blow molding or stretch blow molding a preform in a mold, or by a molding method.

According to a second aspect, the invention proposes a capped container obtained by the method as presented above, in which the neck lacks threading or in which the neck lacks snap-on means.

According to a third aspect, the invention proposes a use of the container that is capped according to the method presented above, comprising an opening step in which the mounting between the sheet and the container is broken, detaching the sheet from the body of the container to allow it to be opened, and a closing step in which the collar of the sheet is placed on the edge of the opening, the central area capping the opening.

To be able to be implemented, the invention is set forth in a sufficiently clear and complete way in the following description that is, in addition, accompanied by drawings in which:

FIG. 1 is an illustration of a bottle-type container comprising a capping system according to the invention,

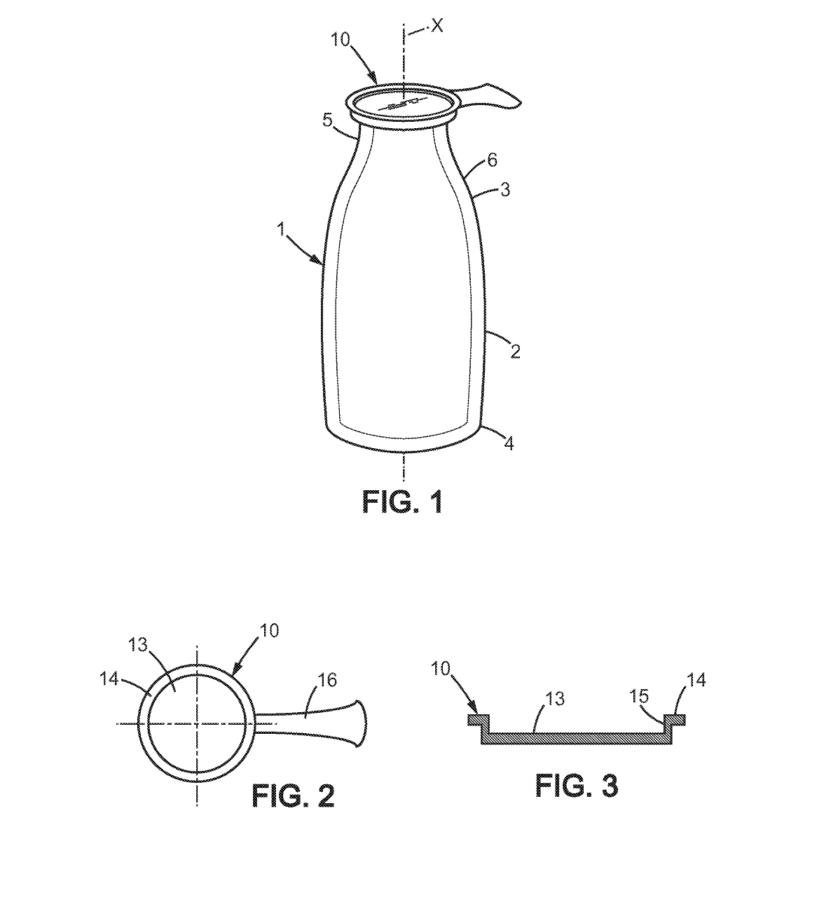

FIG. 2 is a top view of the capping system of FIG. 1,

FIG. 3 is a cutaway view of the capping system of FIGS. 1 and 2,

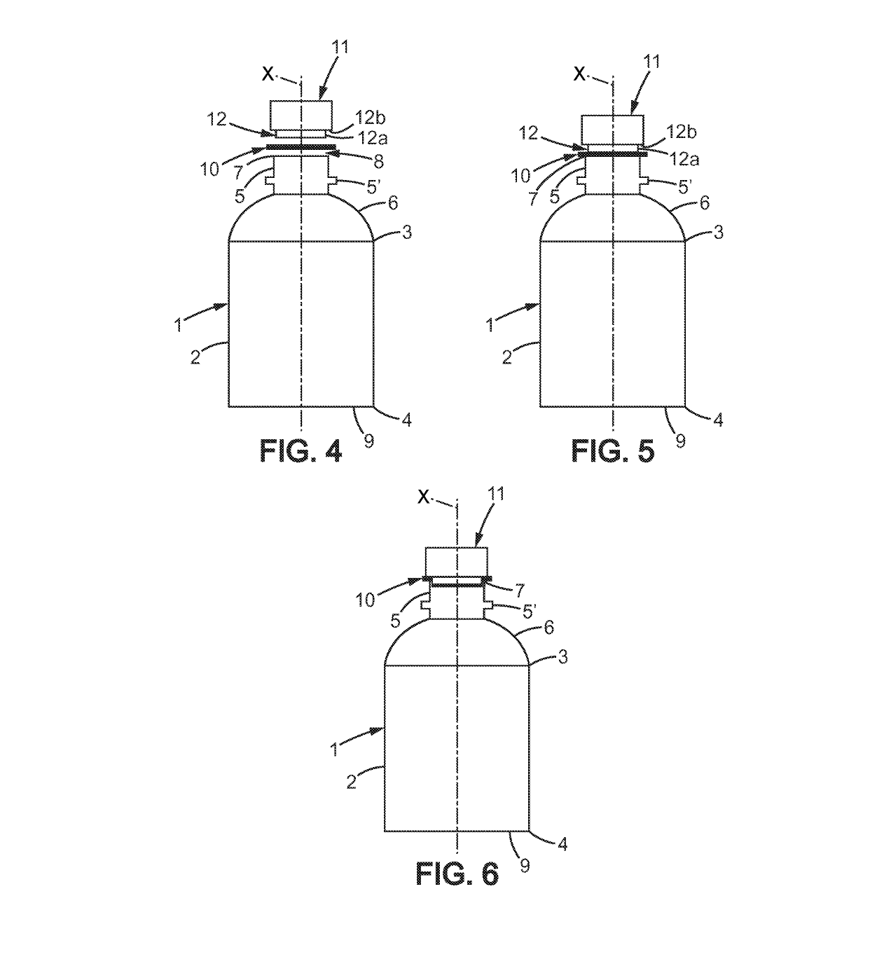

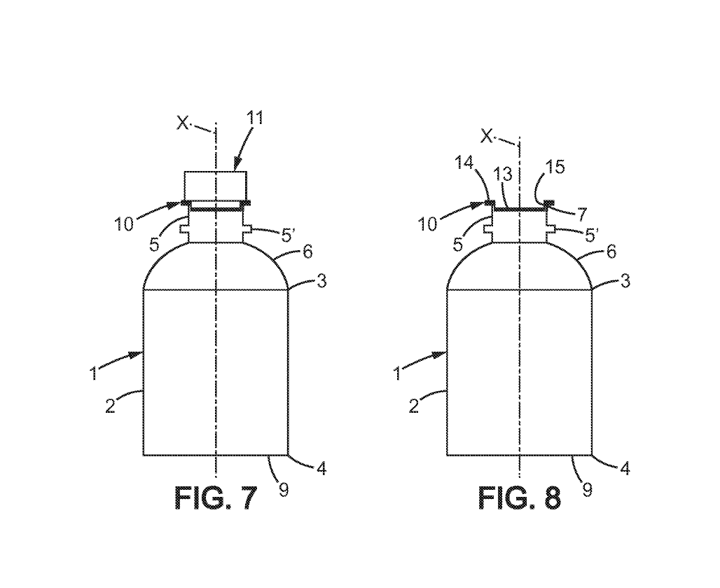

FIGS. 4 to 8 each illustrate successively one step of a method for obtaining the container of FIG. 1.

FIG. 1 illustrates a container 1 that extends along a longitudinal axis X. The container 1 is, for example, a bottle, intended to contain a liquid suitable for drinking.

The container 1 comprises a body 2, extending between an upper end 3 and a lower end 4.

In the following description, the terms “lower,” “upper,” “top,” “bottom,” etc., are used in reference to the drawings for greater ease of understanding. They must not be understood as being limitations of the scope of the invention.

The upper end 3 is topped, in the direction of the main axis X, by a neck 5, with a cross-section that is smaller than the cross-section of the body 2. A shoulder 6 connects the neck 5 to the upper end 3 of the body 2. The neck 5 thus forms a narrowing on the container 1. The neck 5 has a free, open end 7 that forms the edge of an opening 8 (as referenced in FIG. 4) toward the interior of the container 1.

In what follows, the terms “interior,” “exterior,” “inside,” within,” etc., are used with reference to the container 1, which delimits an interior volume.

The lower end 4 of the body 2 of the container 1 is closed by a bottom 9.

The container 1 can have, as illustrated in FIG. 1, a general shape that is rotationally symmetrical around the longitudinal axis X. However, such a symmetry is by no means necessary. The opening 8 and its edge 7 have, for example, a circular cross-section.

The container 1 can be made of thermoplastic material, such as PET, and is formed by, for example, a method of molding, blow molding or stretch blow molding, from a preform. As a variant, the body 2 of the container is made of paperboard; the neck 5, made of thermoplastic material, is rigidly mounted on the body 2. The neck 5 can have a collar 5′ projecting transversely, serving as a support during different manufacturing steps of the container.

The opening 8 of the neck 5 is capped by means of a sheet 10 shaped in the form of a cap, according to a capping method that will now be described.

Shaping is defined here as making a permanent deformation.

The sheet 10 initially appears in the form of a disk of thin material, whose thickness is on the order of a millimeter or less. The sheet 10 is made of ductile material, i.e., it is intended to be deformed plastically under the action of minimal stress without breaking. For example, it is made of thermoformable material, i.e., it can be deformed plastically without breaking after having undergone a temperature increase.

In a first step, the sheet 10 is applied over the entire edge 7 of the opening 8 of the container 1. The sheet 10, in the form of a disk, is centered on the longitudinal axis X so as to cover the opening 8 completely.

In a second deep drawing step, the sheet 10 is deep drawn in the opening 8. For this purpose, a die 11 comprises an impression 12 corresponding to the opening 8 and to its edge 7. The die 11 can be moved in translation along the longitudinal axis X. As a variant, it is the container 1 that can be moved in translation along the longitudinal axis X. More specifically, the impression 12 of the die 11 is formed by two portions. A first portion 12a extends along the longitudinal axis X over a distance on the order of a centimeter and has a cross-section corresponding approximately to the interior cross-section of the neck 5. The second portion 12b also extends along the longitudinal axis X and has a cross-section whose dimensions are greater than those of the cross-section of the opening 8. During the deep drawing step, the first portion 12a of the impression 12 of the die 11 enters into contact with the sheet 10 and penetrates to the interior of the neck 5 through the opening 8 until the second portion 12b strikes against the edge 7 of the opening 8 while crushing the sheet 10 against the edge 7.

So as to facilitate the deep drawing step, the sheet 10, then made of thermoformable material, can be heated. The heating can take place just before, or during, the deep drawing, the die 11 then comprising heating means for this purpose.

The die 11, optionally associated with a heating step, thus exerts a sufficient stress on the sheet 10 to deform it plastically.

The sheet 10 shaped in the form of a cap by deep drawing, optionally cooled, then has a central area 13 that penetrates to the interior of the container through the opening 8 over a distance on the order of a centimeter. The central area 13 is surrounded by a collar 14, pressing on the edge 7 of the opening 8. The central area 13 and the collar 14 of the sheet 10 are offset along the longitudinal axis X in relation to one another (in other words, the collar 14 and the central area 13 are in offset planes). Thus, during the deformation, a junction area 15 is created between the central area 13 and the collar 14 of the sheet 10. The junction area constitutes a riser 15 between the collar 14 and the central area 13 and is advantageously in contact with the interior wall of the neck 5. The central area 13 has a circular cross-section, adapted to the opening 8. The collar 14 of the sheet 10 is also circular, limiting in particular the bulk beyond the edge 7 of the opening 8.

In a third step, known as mounting, the deep drawn sheet 10 is mounted on the neck 5, thus ensuring the interlocking of the sheet 10 on the body 2 of the container 1.

According to one embodiment, the mounting is performed by sealing between the collar 14 of the sheet 10 and the edge 7 of the opening 8. As a variant, or in combination, the sealing is performed between the riser 15 and the interior wall of the neck 5.

The sealing step can take place at the same time as the deep drawing step. For this purpose, the die 11 is equipped with heating means bringing the sheet 10, and optionally the neck 5, to a temperature that is sufficient to bring about the sealing.

As a variant, the mounting is performed by adhesion. For this purpose, for example, prior to the step of applying the sheet 10, the edge 7 of the opening 8 of the neck 5 is, coated with a layer of sealant, preferably an edible sealant. The pressure exerted by the die 11 on the sheet 10 against the edge 7 ensures the setting of the sealant on the sheet 10.

The mounting step ensures a fluidtight contact between the collar 14 of the sheet 10 and the edge 7 and/or between the riser 15 and the interior wall of the neck 5.

When the die is moved along the longitudinal axis X in order to move away from the sheet 10, the sheet 10 remains mounted rigidly on the neck 5.

The sheet 10 thus forms a cap, preventing the liquid from escaping out of the container, and preventing outside bodies from penetrating into the container.

So as to facilitate the opening of the container by pulling out the sheet 10, it can comprise a portion projecting transversely, from the collar 14 of the sheet 10, and forming the gripping area 16, as can be seen in FIGS. 1 and 2.

As a variant, the collar 14 can have a square shape in which the opening 8 lies. The corners of the collar 14 extending beyond the edge 7 of the opening 8 then form gripping areas.

It is understood that the collar 14, and the sheet 10 in general, can be of any shape, covering the opening 8.

To open the container, a user grasps the gripping area 16 and exerts a force to break the mounting between the sheet 10 and the neck 5. The sheet 10 is thus detached from the container 1. However, the sheet 10 maintains it cap shape, i.e., the central area 13, the collar 14, and the riser 15. The choice of material and of the thickness of the sheet 10 makes it possible to prevent the sheet 10 from tearing during the breaking of the mounting.

To reclose the container, the sheet 10 can be placed again over the opening 8, while inserting the central area 13 into the opening 8 to cap it, the collar 14 of the sheet 10 pressing against the edge 7. Although the mounting is broken, the shape of the cap-shaped sheet 10 makes possible an interlocking between the sheet 10 and the container 1, limiting the risks that the contents of the container escape out of the container or that foreign bodies penetrate into the container 1.

The sheet 10 can be made of flexible or rigid material.

Flexible is defined here as the property of the sheet 10 to be deformed elastically under the effect of a specified maximum stress under normal conditions of use of the container 1.

Rigid is defined here as the property of the sheet 10 to maintain its shape under the action of a specified maximum stress under normal conditions of use of the container 1.

For example, the sheet 10 is made of thermoplastic material, or of metal such as aluminum.

The neck 5 no longer requires specific means for receiving a cap, such as a threading or snap-on means. The neck 5 in fact lacks such means.

The sheet 10 thus provides a cap at low cost, making it possible, moreover, to reclose the opening 8 of the container 1.

1. Method of capping a hollow container (1), the container (1) comprising a body (2) that extends between an upper end (3) and a lower end (4), the upper end (3) being topped by a neck (5) forming a narrowing on the container (1) and defining an opening (8) to the interior of the container (1), and the lower end (4) comprising a bottom (9) that closes the container (1), the capping method comprising the following steps:
the application of a sheet (10) over the entire edge (7) of the opening (8) of the container (1) in such a way as to cover the opening (8),
the deep drawing of the sheet (10) into the opening (8) of the neck (5) of the container (1) by a die (11), so that the sheet (10) forms a collar (14) pressed against the entire edge (7) of the opening (8), a central area (13) surrounded by the collar (14) and being located in a plane that is offset relative to this collar, and a junction area between the collar (14) and the central area (13), the junction area forming a riser (15) in contact with the interior wall of the neck (5),
the mounting of the sheet (10) that is deep drawn onto the neck (5) ensuring the interlocking of the sheet (10) onto the body (2) of the container (1).

2. Method according to claim 1, in which the sheet (10) is made of thermoplastic material.

3. Method according to claim 1, in which the sheet (10) comprises at least a portion extending beyond the edge of the opening, so as to form a gripping area (16) after the deep drawing step.

4. Method according to claim 1, in which the mounting step comprises a step for sealing between the sheet (10) and the neck (5).

5. Method according to claim 4, in which the sealing is performed between the collar (14) and the entire edge (7) of the opening (8), so that the collar (14) of the sheet is in fluidtight contact with the edge (7) of the opening (8).

6. Method according to claim 4, in which the sealing is performed between the riser (15) and the interior wall of the neck (5), so that the riser (15) is in fluidtight contact with the interior wall of the neck (5).

7. Method according to claim 4, in which the sealing step is simultaneous with the deep drawing step.

8. Method according to claim 1, in which the mounting step comprises a step for adhesion between the sheet (10) and the neck (5).

9. Method according to claim 1, in which the deep drawing step is accompanied by a step for heating the sheet (10).

10. Method according to claim 1, in which the neck (5) of the container (1) is made of thermoplastic material.

11. Method according to claim 1, in which the body (2) of the container (1) is made of thermoplastic material.

12. Capped container (1) obtained by the method according to claim 1, in which the neck (5) lacks threading.

13. Capped container (1) obtained by the method according to claim 1, in which the neck (5) lacks snap-on means.

14. Method of using a capped container (1) according to claim 1, comprising an opening step in which the mounting between the sheet (10) and the container (1) is broken, detaching the sheet (10) from the body of the container (1) to allow it to be opened, and a closing step in which the collar (14) of the sheet is placed on the edge (7) of the opening (8), the central area (13) capping the opening (8).

15. Method according to claim 2, in which the sheet (10) comprises at least a portion extending beyond the edge of the opening, so as to form a gripping area (16) after the deep drawing step.

16. Method according to claim 5, in which the sealing is performed between the riser (15) and the interior wall of the neck (5), so that the riser (15) is in fluidtight contact with the interior wall of the neck (5).

17. Method according to claim 5, in which the sealing step is simultaneous with the deep drawing step.

18. Method according to claim 6, in which the sealing step is simultaneous with the deep drawing step.
